(19) United States
(12) Patent Application Publication
(10) Pub. No.: US 2017/0057138 A1
(43) Pub. Date: Mar. 2, 2017

(54) INJECTION MOLDING NOZZLE TIP AND ASSEMBLY INCLUDING SUCH A TIP

(71) Applicant: Injection Mold Consulting, LLC, Trevose, PA (US)

(72) Inventor: James Gary Fattori, Trevose, PA (US)

(73) Assignee: Injection Mold Consulting, LLC, Trevose, PA (US)

(21) Appl. No.: 15/189,492

(22) Filed: Jun. 22, 2016

Related U.S. Application Data
(60) Provisional application No. 62/212,360, filed on Aug. 31, 2015.

(51) Int. Cl. B29C 45/20; B29C 45/03

(52) U.S. Cl. CPC B29C 45/20; B29C 45/03; B29C 2045/207; B29K 2101/12

(57) ABSTRACT

An injection molding nozzle tip includes a body extending along a central axis and having a front end and a rear end. A passage extends along the axis, through the body and forms a front opening at the front end, and a rear opening at the rear end. At least one fin extends radially inwardly from an inner surface of the passage.

### CROSS REFERENCE TO RELATED APPLICATION

This application claims the benefit of U.S. Provisional Patent Application No. 62/212,360, filed Aug. 31, 2015, which is incorporated herein by reference as if fully set forth.

### FIELD OF THE INVENTION

The invention relates generally to thermoplastic injection molding equipment, and more particularly to an injection molding nozzle tip.

### BACKGROUND

Injection molding is a well know process that involves melting solid thermoplastic molding material within a heated machine barrel assembly mounted on a moveable carriage, and transmitting the molding material into a cavity formed within an injection mold. The molding material takes on the shape of the cavity and then solidifies to form a finished part. The mold then opens and the process may be repeated to form additional parts.

The heated machine barrel assembly includes a nozzle having a tip that engages a complimentary nozzle seat formed in the injection mold.

The molding material may be solid, semi-rigid, or molten at various stages of an injection molding operation, and while the nozzle tip may contain molding material in any or all of these physical states, there will always be at least some semi-rigid material located between solid and molten molding material. Crystalline thermoplastic materials will typically have a small amount of semi-rigid material between the other two states, while amorphous thermoplastic materials typically contain a considerably larger amount of semi-rigid material. Control of these three physical states and their location within the nozzle tip is critical to the performance of the molding process.

Injection molds have a truncated conical void, known as a “sprue,” beginning at the surface of the nozzle seat and positioned inwardly toward the center of the mold. The sprue is typically contained within a sprue bushing. When a molded part has sufficiently solidified, the mold opens, allowing removal of the molded part and the solidified sprue, and often an undesirable string of material is formed between the end of the solidified sprue and the molten material within the nozzle tip. The length of these strings may range from a fraction of an inch to several feet long. The end of a string is typically thin and light in weight.

Some molds have a sprue bushing that is electrically heated, known as a “hot bushing.” A hot bushing keeps the molding material in a molten state between the nozzle tip and the mold parting line, or directly to the cavity within the mold. The end of the hot bushing typically has an interchangeable component also referred to as a nozzle tip.

Injection molds may also include a hot runner system, wherein components called “probes” or “nozzles” are typically connected to an electrically heated manifold block. Such a hot runner system provides for a plurality of heated material passageways to the injection mold. Some variations of these probes or nozzles include a component also referred to as a nozzle tip or probe tip.

Hot bushing nozzle tips and hot runner nozzle tips are also subject to the formation of strings.

A string typically originates from the cross sectional center of molding material in the nozzle tip, where the molding material is often still molten at the end of the molding cycle. As the outer surface of the molten material solidifies from being in contact with the cooler material, for example steel, of the nozzle tip passage, it insulates the center section, which then solidifies at a slower rate. As the molten material cools, it shrinks away from the surface of the nozzle tip passage, which results in a further reduction of thermal conductivity, slowing down solidification. A string will often form when the cycle time of the mold is less than the time required for the material within the passage of the nozzle tip to solidify.

The variation in solidification rates between the molding material in the nozzle tip and the molding material in the mold is primarily due to the nozzle tip being conductively heated by the machine barrel assembly, while conversely, the mold is being cooled, typically by water, in channels throughout the mold.

Particularly long strings may drape and adhere to the parting line or face of the open mold. This adherence is aided by static electricity between the strings and the parting line. When the mold closes to start the next cycle, the string can damage the parting line, which can be expensive to repair. The string can also drape over the cavity and result in an aesthetically unacceptable or rejected part. Therefore, it would be beneficial to use a nozzle tip which is not prone to stringing.

One method molders use to control stringing is to extend the length of time the molded part remains within the mold, providing additional time for the molding material within the passage of the nozzle tip to solidify. This method reduces efficiency and increases the cost of the molded parts.

Another method commonly used to eliminate stringing employs a nozzle tip with a reduced internal passage diameter. The molding material within the smaller diameter passage with its smaller cross sectional flow area often solidifies before the molded part has solidified. Using a smaller diameter nozzle tip can cause other problems, such as higher injection pressures, high shear rates and material degradation.

The machine nozzle tip is typically the most restrictive component in the passage of the molding material from the heated barrel assembly to the mold cavity, and can therefore be the weakest link in the melt delivery system.

The internal geometry of the nozzle tip has a direct effect on the molding process and the quality and cost of the molded part. Known nozzle tips often have cylindrical or truncated conical internal passages. As the diameter of the passageway decreases, the corresponding flow area decreases, in turn increasing the required injection pressure to fill the molding cavity. Insufficient injection pressure may result in parts having a wavy surface finish, internal voids, incomplete filling, known as shorts, variation in weight and dimension, and other unacceptable conditions. It is therefore beneficial to maximize the flow area of the passageway in the nozzle tip.

Additionally, as the diameter of the passageway decreases, the amount of heat generated by frictional shear increases, reducing the viscosity of the material, which can cause the material to flow into extremely thin crevices, resulting in additional unwanted material called “flash.” Excessive shear heat can cause the material to degrade and burn, which can have a negative effect on both the aesthetic and physical properties of the molded part. This degradation can also cause the mold to become stained, which would require expensive cleaning and polishing in order to produce an acceptable part.

Since the distal end of the nozzle tip is connected to the heated barrel assembly, and the proximal end of the nozzle tip abuts the colder injection mold, there is a large temperature differential between the two ends. Controlling the distribution and location of this temperature differential is important for controlling the injection molding process.

Heat transfer via conduction between the proximal end of the nozzle tip and the concave nozzle seat on the injection mold often is greater than desired. This is typical when there is excessive physical contact area between the nozzle tip and the sprue bushing, particularly when both have small openings. This condition can cause a small amount of material to solidify and remain within the nozzle tip when the mold opens to remove the part, which is known in the plastics industry as “freeze-off,” and the material remaining inside the nozzle tip is known as a “cold slug.” Upon the start of the next molding cycle, tremendous injection pressure is required to dislodge the cold slug inside the nozzle tip, and inject it into the mold. Once dislodged, the cold slug can travel through the mold passageways and into the mold cavity, resulting in undesirable silver streaks on the outside of the molded part, typically referred to in the industry as “splay.”

Many cold slugs are not completely solid, but may be semi-rigid and highly viscous, like putty. The viscous slug of molding material is often either pulled out with the solidified molded sprue, or it breaks off from the sprue and remains within the passageway of the nozzle tip. It is not uncommon for the cold slug to randomly alternate between the two scenarios. This condition causes a variation in the amount of material injected into the mold, which is referred to as the “shot size.” When molding a small part, this variation in shot size can cause the molded part to contain an insufficient or excessive amount of material, and can vary from cycle to cycle. Therefore, it is beneficial to have a nozzle tip that promotes a distinct and repeatable separation point between the solidified sprue and the molten or semi-molten material in the nozzle tip.

Molders often increase the temperature of the heated barrel assembly, particularly near the nozzle tip, to prevent cold slugs from forming. However, this increase in temperature can cause the molding material to degrade, particularly if the material is temperature or shear sensitive, such is the case with Polyvinyl Chloride (PVC). Many re-ground and recycled materials are also shear sensitive, due to the reduction of lubricating and heat stabilizing additives from prior molding cycles. Since material degradation is not always visible on the surface of a part, it is beneficial to have a nozzle tip that minimizes shear to prevent degradation and permit the use of re-ground and recycled material without jeopardizing the quality of the molded part.

Since most thermoplastic materials expand when heated, excessive temperatures can also cause small amounts of molten material to extrude out of the proximal opening of the nozzle tip, which is often referred to as “drool.” Molders may use an insulating material, such as paper, aramid fiber or high heat insulating discs to reduce the thermal conductivity between the nozzle tip and sprue bushing. These insulators can work well in some cases, such as with small orifice diameters, but are difficult and troublesome to use in a production environment, and are very ineffective on large orifice diameters, such as those greater than ¼ inch in diameter.

One skilled in the art of injection molding knows that there is a temperature range at which nozzle tips can be set and will be hot enough not to create cold slugs, yet cold enough to avoid drool or degradation of the thermoplastic material. This temperature range can be very wide or very narrow depending on many factors, such as the type and design of the nozzle tip, the size of the passage within the nozzle tip, the type of thermoplastic molding material, the amount of conductive heat loss from the proximal end of the nozzle tip to the abutting injection mold, the cycle time of the machine, and the injection flow rate of the material through the nozzle tip, among others.

Ideally, the molding process parameters should be established to produce an ideal molded part, and not established to prevent strings, cold slugs or freeze offs.

In the Unites States, injection mold component suppliers offer sprue bushings with entrance orifices in four standard sizes: 5/32 inch, 7/32 inch, 9/32 inch and 11/32 inch. Nozzle tips are commercially available with exit orifices in twelve standard sizes, from 1/16 inch to ½ inch in thirty-secondth increments, or 1/16 inch, 3/32 inch, ⅛ inch, 5/32 inch, 3/16 inch, 7/32 inch, ¼ inch, 9/32 inch, 5/16 inch, 11/32 inch, ⅜ inch, and ½ inch

Molders will typically use either a nozzle tip and sprue bushing having the same size orifice, or a nozzle tip with a smaller orifice than the sprue bushing. If the nozzle tip orifice is larger in diameter than the sprue bushing orifice, the solidified material in the nozzle tip may create an undercut condition and not pass through the sprue bushing orifice, which can cause the solidified sprue to separate from its adjoining structure and remain within the sprue bushing when the mold opens. If a solidified sprue is not removed, it typically prevents the molding material from entering the mold at the start of the next cycle.

When the same orifice size nozzle tip and sprue bushing are used, the same undercut condition may be created by a misalignment of the two openings due to the difficulty in positioning the injection mold perfectly within the molding machine, and the heated barrel assembly not being perfectly positioned in the ideal mold location.

In addition to the formation of an undercut condition, misaligned nozzle tips and sprue bushings also result in a reduced flow area and generate more shear than if they were in proper alignment.

In the United States, the two most common commercially available nozzle tip and sprue bushing spherical surface radii are ½ inch and ¾ inch. It is a challenge to perfectly align the nozzle tip with the sprue bushing. Additionally, the dimensional accuracy of the ½ inch and ¾ inch spherical surfaces varies between manufacturers and from nozzle tip to nozzle tip. These dimensional variations can cause molding material leakage, resulting in a number of problems. One such problem known as “blow back,” is when there is sufficient force generated during injection to cause the entire heated machine barrel assembly and the associated carriage, to shift away from the sprue bushing.

Therefore, the standard practice is to use a nozzle tip with an orifice which is at least 1/32 inch smaller in diameter than the orifice of the sprue bushing. This reduced diameter allows for the passage of molding material without the creation of an undercut condition due to misalignment, but it reduces the maximum potential flow area. The smaller the sprue bushing orifice diameter, the greater the percentage of flow reduction caused by using a nozzle tip with an orifice 1/32 inch smaller in diameter, as shown in Table I.

| | | | | Flow | Flow | |
|---|---|---|---|---|---|---|
| Sprue | | 1/32″ | | Area of | Area of | |
| Bushing Orifice | | Smaller Nozzle Tip | | Sprue | Nozzle | Percent |
| Diameter | | Orifice Diameter | | Orifice | Orifice | Less Flow |
| Fractional | Decimal | Fractional | Decimal | (In²) | (In²) | Area |
| 11/32 | 0.344 | 5/16 | 0.313 | 0.093 | 0.077 | 17% |
| 9/32 | 0.281 | ¼ | 0.250 | 0.062 | 0.049 | 21% |
| 7/32 | 0.219 | 3/16 | 0.188 | 0.038 | 0.028 | 27% |
| 5/32 | 0.156 | ⅛ | 0.125 | 0.019 | 0.012 | 36% |

Therefore, it would be beneficial to use a nozzle tip which has an opening diameter only slightly smaller than the sprue bushing opening diameter, to compensate for slight misalignment, as opposed to a full 1/32 or 0.031 inch smaller diameter.

### SUMMARY

The invention relates to an injection molding nozzle tip, including a body extending along a central axis and having a front end and a rear end. A passage extends along the axis, through the body and forms a front opening at the front end, and a rear opening at the rear end. At least one fin extends radially inwardly from an inner surface of the passage.

The invention further relates to an injection molding nozzle tip, including a body extending along a central axis and having a front end and a rear end. A passage extends along the axis, through the body and forms a front opening at the front end, and a rear opening at the rear end. A transition plane is located along the axis intersecting the passage. The passage includes a front segment located between the transition plane and the front end, and a rear segment located between the transition plane and the rear end. The rear segment includes a first section located adjacent to the rear end and a second section located between the first section and the transition plane. The first section includes a conical inner surface that narrows from the rear end to the second section. The second section includes a curved inner surface that narrows from the first section to the transition plane. The curved inner surface has a radial center point offset from the central axis.

The invention further relates to an injection molding assembly, including an injection mold having an inlet opening in communication with a molding cavity. The assembly further includes an injection molding nozzle tip configured for engagement with the mold and having a body extending along a central axis, a front end in contact with the inlet opening and defining a front end opening, a rear end defining a rear end opening, and a passage for transmission of molding material from the rear end opening to the front end opening. The inlet opening has an inlet opening diameter and the front end opening has a front end opening diameter. The front end opening diameter is smaller than the inlet opening diameter.

The invention further relates to an injection molding assembly, including an injection mold having an inlet having a concave surface and defining an inlet opening in communication with a molding cavity. The assembly further includes an injection molding nozzle tip configured for engagement with the mold and having a body extending along a central axis. The nozzle tip includes a front end including a nodule having a forward extending domed convex surface in contact with the inlet opening and complimentary to the concave surface. A front end opening is defined in the domed convex surface. The nozzle tip further includes a rear end defining a rear end opening. The nozzle tip defines a passage for transmission of molding material from the rear end opening to the front end opening. The concave surface has a standard concave surface radius, and the convex surface has a non-standard convex surface radius. The convex surface radius is smaller than the concave surface radius.

The invention further relates to an injection molding nozzle tip, including a body extending along a central axis and having a front end and a rear end. A passage for transmission of molding material extends along the axis, through the body and forms a front opening at the front end, and a rear opening at the rear end. The nozzle tip further includes hexagonal section forming a plurality of wrench flats on an exterior surface of the body. The hexagonal section is axially located between the front end and the rear end. The body has a reduced mass area, formed as an area of minimum diameter that extends from the hexagonal section and the front end.

### BRIEF DESCRIPTION OF THE DRAWINGS

FIG. 1 is an isometric view of an injection molding nozzle tip according to the invention.

FIG. 2 is a side plan view of the nozzle tip of FIG. 1.

FIG. 3 is a front plan view of the nozzle tip of FIG. 1.

FIG. 4 is an enlarged detail of FIG. 3.

FIG. 5 is a rear plan view of the nozzle tip of FIG. 1.

FIG. 6 is a cross section taken along line 6-6 of FIG. 3.

FIG. 7 is an enlarged detail of FIG. 6.

FIG. 8 is a cross section taken along line 8-8 of FIG. 3.

FIG. 9 is a side plan view of the nozzle tip of FIG. 1, shown from the opposite side as in FIG. 2.

FIG. 10 is an enlarged longitudinal cross sectional view of an injection molding nozzle tip according to the invention engaged with a sprue bushing seat.

FIG. 11 is a front perspective view of an embodiment of an injection molding nozzle according to the invention.

FIG. 12 is a side plan view of the nozzle of FIG. 11.

FIG. 13 is a partial longitudinal cross sectional assembly view of the tip of FIG. 11.

FIG. 14 is a side elevational view of another embodiment of a nozzle tip according to the invention.

FIG. 15 is a cross section of another embodiment of an injection molding nozzle according to the invention.

FIG. 16 is a cross section of another embodiment of an injection molding nozzle according to the invention.

### DETAILED DESCRIPTION OF THE PREFERRED EMBODIMENTS

Certain terminology is used in the foregoing description for convenience and is not intended to be limiting. Words such as “front,” “back,” “top,” and “bottom” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

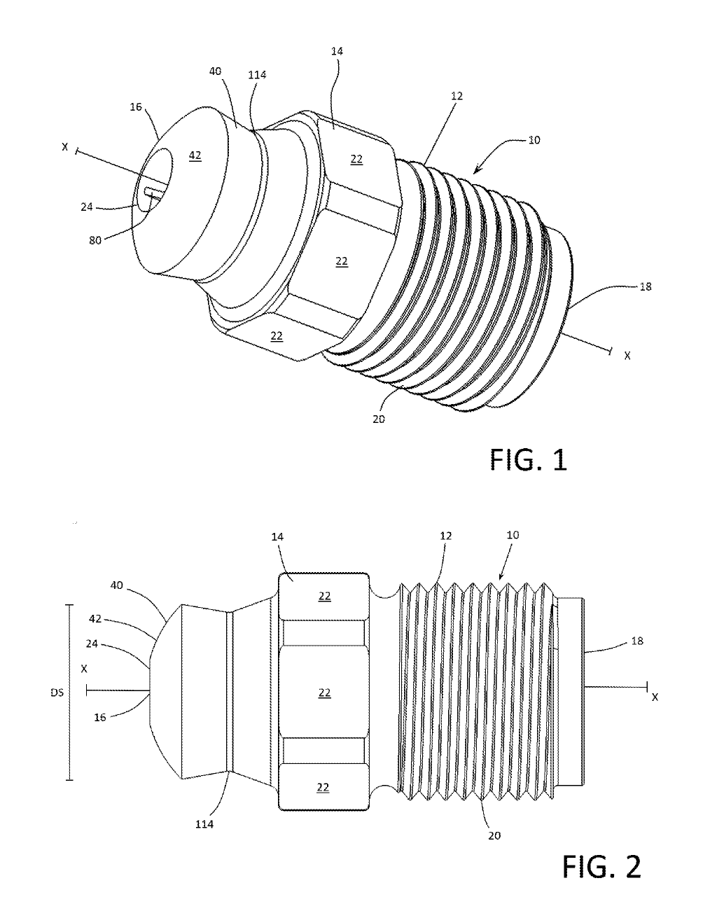

An injection molding machine nozzle tip 10 according to the invention is shown in FIGS. 1-9. The tip 10 has an elongate, generally tubular body 12 extending along a central axis X and having a front end 16 and a rear end 18. An exterior thread 20 is formed on the outside of the body 12, extending from a generally central area along the axial length thereof, to the rear end 18. A plurality of wrench flats 22 are formed within a hexagonal section 14 on the outside of the body 12, extending from the central area between where the thread 20 terminates and the front end 16. In use, the wrench flats 22 are gripped using a suitable tool, and the tip 10 is screwed into the heated barrel assembly of an injection molding machine such that the exterior thread 20 engages a complimentary interior thread of the barrel assembly, to affix the nozzle tip 10 to the molding machine in a manner known in the art. When affixed to a molding machine in this manner, the rear end 18 abuts a counter bore in the heated barrel assembly to form a leak-proof seal.

A nodule 40 protrudes in a forward direction from the hexagonal section 14. The nodule 40 includes a domed convex surface 42 extending forward therefrom in an axial direction of the tip 10. In use, the domed convex surface 42 abuts a complimentary concave surface formed in the injection mold.

A front opening 24 is formed at the front end 16 of the tip 10, within the domed convex surface 42, and a rear opening 26 is formed at the rear end 18. A passage 60 is defined along the axial length of the tip 10 for the flow of molten molding material between the front opening 24 and the rear opening 26. In use, the molding material travels from the heated barrel assembly of the molding machine into the rear opening 26, through the passage 60, and to the front opening 24, through which the molding material exits the tip 10 and is injected into the injection mold.

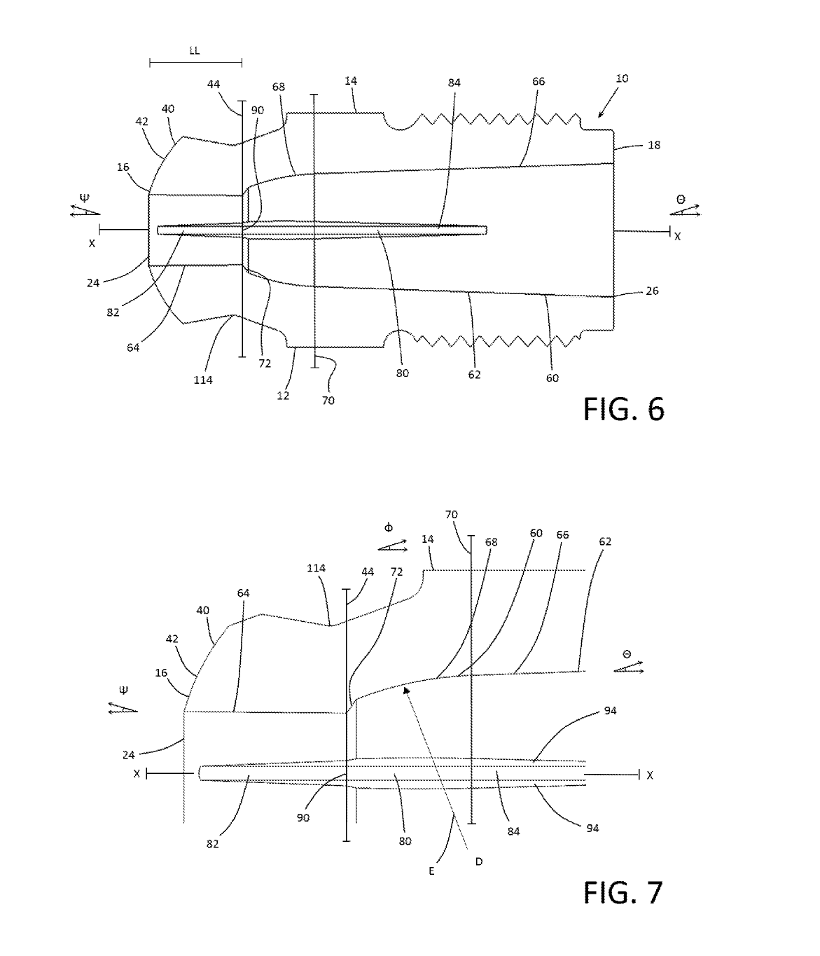

Referring to FIGS. 6-8, a transition plane 44 extending perpendicularly to the central axis X passes through a section of the body 12. As used herein, the term “transition plane” is defined as a planar location along the axial length of and perpendicular to the passage 60, at which solidified molding material is repeatedly coerced to separate from semi rigid molding material within the tip 10 during the mold opening stage of the molding cycle due to a large temperature differential between the front and rear segments. The transition plane 44 may be located, for example, between 0.200 inches and 0.600 inches from the front end 16. The transition plane 44 divides the passage 60 into a rear segment 62 between the rear end 18 and the transition plane 44, and a front segment 64 between the transition plane 44 and the front end 16. During the first phase of a molding cycle, molten plastic material passes first through the rear segment 62, and then through the front segment 64.

Referring to FIGS. 6-8, the rear segment 62 of the passage 60 includes a first section 66, located adjacent to the rear end 18, and a second section 68, located between the first section 66 and the transition plane 44.

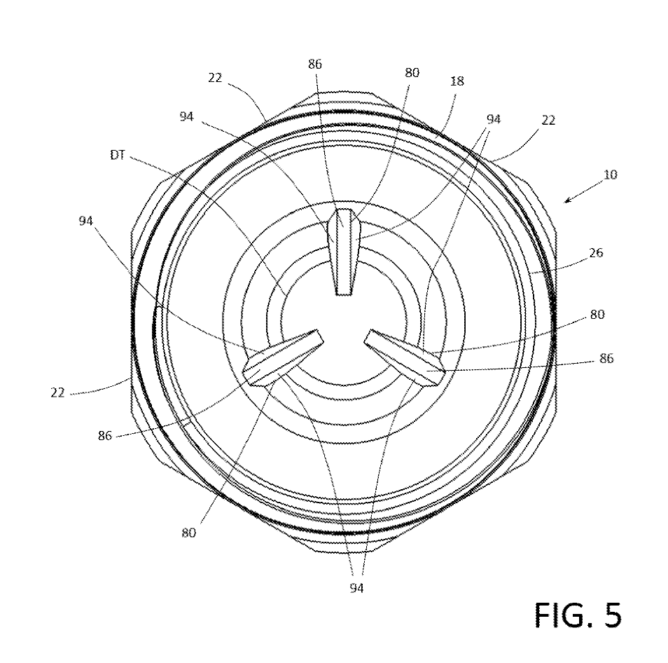

The first section 66 inner surface conically narrows at an angle θ with respect to the central axis X in an axial direction of the tip, travelling from the rear end 18 towards the transition plane 44. In some embodiments, the angle θ may range from 0° to 8°, for example from 0° to 2°. In some embodiments, the angle the angle θ may range from ¼° to 8°, and in some embodiments the angle θ may range from 0.5° to 6°. In embodiments in which the passage 60 has a relatively small diameter DT (FIG. 5) at the transition plane 44, the angle θ may have a relatively large value, for example closer to 8°. In embodiments in which the passage 60 has a relatively large diameter DT at the transition plane 44, the angle θ may have a relatively small value, for example closer to ¼°. In such embodiments, angle θ is designed to minimize increased shear to the molding material and to maximize the volume of molding material within the rear segment 62, to encourage the molding material to remain in a molten state.

The second section 68 has a curved inner surface that continues to reduce in diameter when compared to the first section 66, as it extends inwardly towards the transition plane 44.

Between the first section 66 and the second section 68 is an adjoining plane 70. The internal radius of the curved surface in the second section 68 ranges from ⅛ inch to 1½ inches, in some embodiments between ½ inch and 1½ inches. The center point D of the radius E is radially displaced from the axis X, as shown in FIG. 7. The offset inner radius E center D creates a smooth transition between the first section 66 and the transition plane 44, so as to avoid the formation of a “hang-up” area, particularly with smaller front opening sizes, where the molding material can become trapped and in turn stagnate and degrade, which may result in a reduction in the physical properties and aesthetic quality of the molded parts.

The narrowing angle θ in combination with the selected offset radial center point D of the adjoining second section 68 further avoids any abrupt changes in diameter, which could result in rapid acceleration of the molding material within the passage 60 and in-turn negatively affect the viscosity and associated shear of the molding material. As is known in the art, rapid changes in velocity may effect on the viscosity of the material, and undesirable flashing, i.e., excess material being attached to the finished part at the injection site, may occur when the viscosity of the molding material is too low.

The rear segment 62 of the passage 60 further includes a chamfered region 72 formed between the second section 68 and the transition plane 44. The chamfered region 72 may have a radial extension between 0.010 inches and 0.060 inches, for example between 0.010 inches and 0.050 inches. The chamfered region extends at a chamfer angle φ, as shown in FIG. 7, with respect to the central axis X which may be greater than the angle θ. The chamfer angle φ may be between 30° and 60°. The radial length of the chamfered region 72 is sufficiently small and the chamfer angle φ within a range so as not to cause a hang-up area as discussed above. The chamfered region 72 further promotes separation of the solidified molding material and the semi-rigid molding material precisely at the transition plane 44. When the solidified molding material repeatedly separates from the semi-rigid molding material at the transition plane 44, the amount of injected molding material, known as “shot size,” is more precisely repeatable from cycle to cycle.

Still referring to FIGS. 6-8, the front segment 64 of the passage 60 expands conically outward at an angle ψ formed with respect to the axis X in an axial direction of the tip 10 as it travels from the transition plane 44 toward the front end 16 of the nozzle tip 10. The angle ψ may range from 0° to 5°, for example from 0.25° to 2.0°. The small conical expansion of the front segment 64 maximizes the flow area, while minimizing shear to the molding material and allowing the molding material to easily release from the passage 60 after solidification during molding.

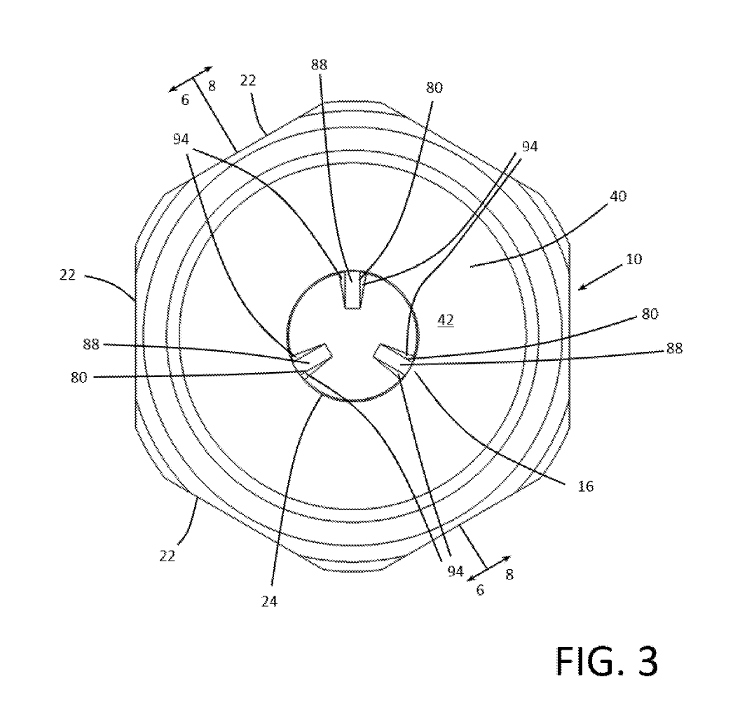

As shown in FIGS. 3-8, at least one inwardly protruding fin 80 extends radially inward from an inner surface of the passage 60. In the embodiment shown, a plurality of fins 80, and in particular three fins 80 are provided and are equally spaced about the inner circumference of the passage 60, i.e., being spaced at 120 degree angular increments about the inner circumference of the passage 60. The radial height of the fins 80 at the transition plane 44 creates a relatively uniform flow area between the side surfaces 94 of each pair of adjacent fins 80 and between the radial inner surfaces 86 of the three fins 80. The height, thickness and angle of the fins 80 will vary depending on the size of the passage 60 and opening 16.

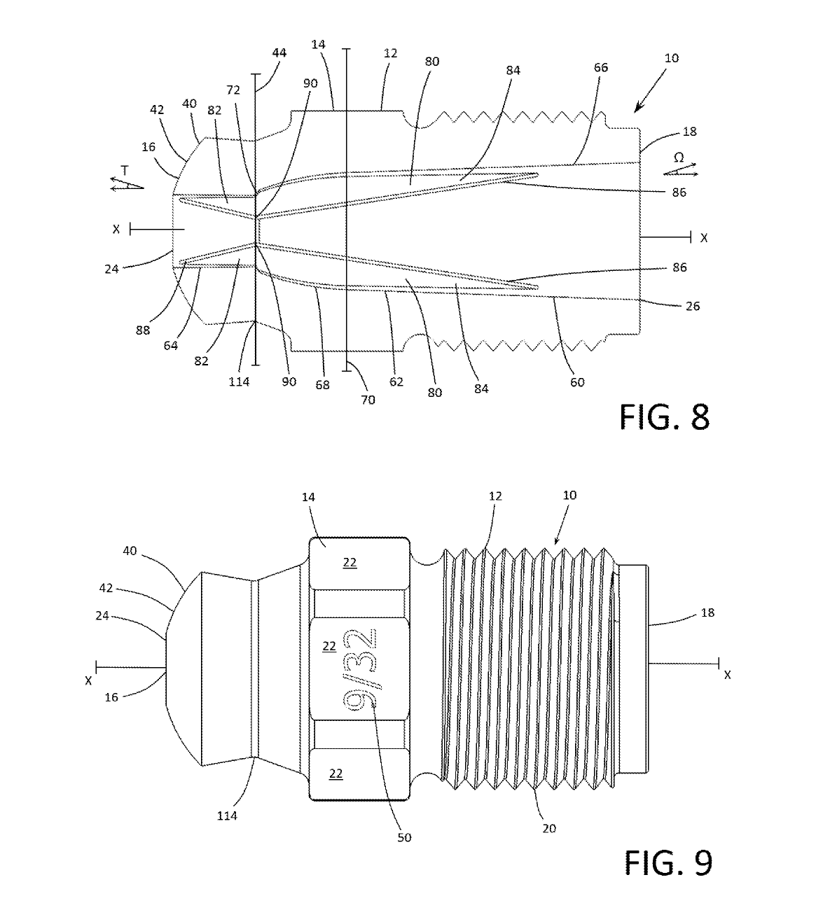

Each of the fins 80 is divided into a front longitudinal fin portion 82 located within and protruding from an inner surface of the front segment 64 of the passage 60, and a rear longitudinal fin portion 84 located within and protruding from an inner surface of the rear segment 62 of the passage 60. The transition plane 44 divides each of the fins 80 into its respective front portion 82 and rear portion 84. As shown in FIG. 8, the rear portion 84 of each fin 80 has a planar first radial inner surface 86 that extends in substantially linear path at a first angle Ω with respect to the axis X, increasing the radial height of each of the fins 80 in a direction extending from the rear end 18 to the transition plane 44. First angle Ω may be between 5° and 20°. As shown in FIG. 8, the rear portions 84 of the fins 80 terminate before reaching the rear end 18 and opening 26 formed thereon, such that the rear portions 84 are entirely contained within the passage 60, avoiding exposure that could result in damage from improper handling and installation. Each of the fins 80 reaches a peak 90 of maximum radial height the transition plane 44, to facilitate separation of the solidified molding material and the semi-rigid molding material at the transition plane. The front portion 82 of each fin 80 has a planar second radial inner surface 88 that extends in a substantially linear path at a second angle T with respect to the axis X, decreasing the radial height of each of the fins 80 in a direction extending from the transition plane 44 to the front end 16. Second angle T may be between 5° and 20°. As shown in FIG. 8, the front portions 82 of the fins 80 terminate before reaching the front end 16 and opening 24 formed thereon, such that the front portions 82 are entirely contained within the passage 60, avoiding exposure that could result in damage from improper handling and installation.

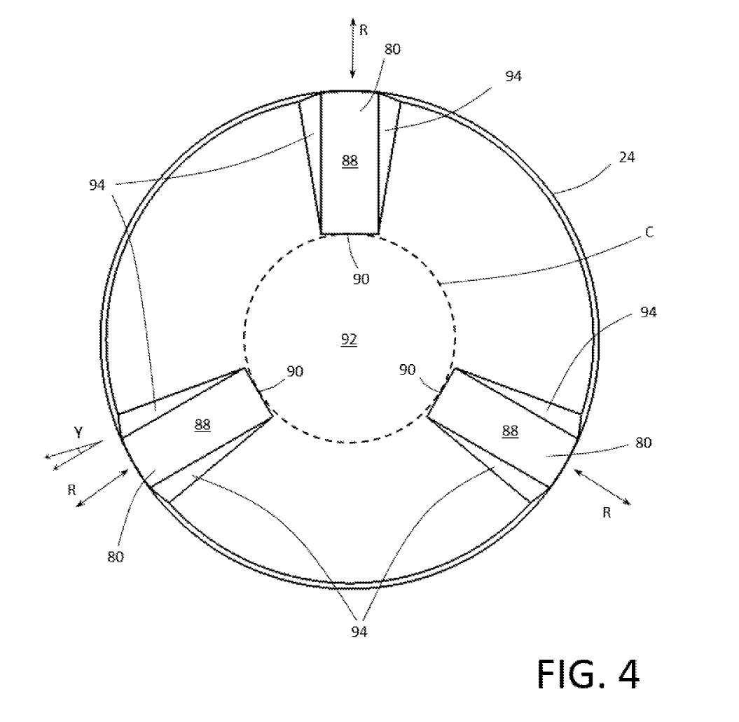

Referring to FIG. 4, the fins at their peaks 90 can be seen within the passage 60. As shown, the peaks 90 are displaced from each other, and in the embodiment shown, the fins 80 do not contact each other at all along their respective axial lengths. A space 92 between the peaks 90 is formed. A circle C within the space 92 and having tangent points at the center of each of the three peaks 90 at the transition plane 44 may have a diameter of 35% to 45% of the diameter of the passage 60 at the transition plane 44. Accordingly, each of the fins 80 extends approximately 60% of the way into the melt stream of the molding material at the transition plane 44. This geometry mitigates reduced solidification rate of the molten molding material located towards the center of the melt stream, typically caused by the outer layer of molding material, which acts as an insulator and undergoes shrinkage during solidification.

Keeping the fins 80 out of contact with each other, and in particular keeping space 92 open, permits molding material to pass through the transition plane 44 in a unitary or a single stream, avoiding unnecessary shear and reducing the time required to switch from one type and/or color of material to another.

The radial inner surfaces 86, 88 of the fins 80 are substantially planar and may have widths ranging from 0.020 inches to 0.060 inches, permitting the fins 80 to maintain their rigidity without overly restricting the flow of molding material or prematurely wearing from abrasive materials. In other embodiments, the radial inner surfaces 86, 88 could be rounded or pointed, each forming a ridge along the axial length of the tip 10.

The fins 80 each further include first and second side surfaces 94, extending on opposite sides of each fin 80 between the inner surface of the passage 60 and radial inner surface 86 or 88. Sides 94 are continuous between the front portions 82 and rear portions 84 of the fins 80 in the embodiment shown, and each extend at a side surface angle Y with respect to the radial extension R of respective fin 80, such that the width of fins 80 at the inner surface of passage 60 decreases as they extend in the radially inward direction. Side surface angle Y may be, for example, between 5° and 15°, or between 10° and 15°. As shown, each fin 80 is widest at its base, where it meets the inner surface of passage 60, for improved strength and heat transference.

The fins 80 accelerate solidification of the molding material at the transition plane 44 and within the front segment 64 of the passage 60 by absorbing heat from the molding material and dissipating it into the cooler surrounding body 12. The dimensions and angled surfaces of the fins 80 may be selected to result in a large or maximized surface area, so as to increase the rate of heat dissipation.

The fins 80 further transfer heat from the rear end 18 of the nozzle tip 10, which is continually heated by the barrel assembly of the molding machine to which it is affixed, to the semi-rigid and molten molding material within the rear segment 62 of the passage, helping to prevent formation of cold slugs, and in turn reducing the need for insulating materials between the nozzle tip 10 and the sprue bushing 100, as well as the use of other devices known in the art with the purpose or preventing cold slug formation.

The combined effects of the front portions 82 of fins 80 absorbing heat from the molding material within the front segment 62 of passage, and the rear portions 84 of fins 80 absorbing and transferring heat from body 12 into the molding material within the rear segment 62 of passage 60 results in a large temperature differential about the transition plane 44 and between the molding material within the front and rear segments 62, 64 of the passage 60 on either side thereof, to help reduce the potential for the formation of both strings and cold slugs.

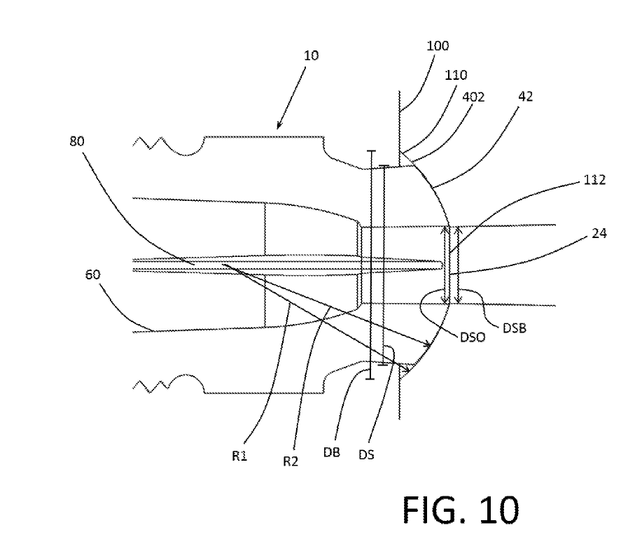

The domed convex surface 42 may have a reduced diameter DS in comparison with that of prior art nozzle tips. The diameter DS may be, for example between 0.500 inches and 0.750 inches. The diameter DS may be closer to 0.750 inches in nozzles with larger front openings 24 and closer to 0.500 inches in nozzles with smaller front openings 24. An exemplary standard nozzle tip of the prior art may have a diameter DS of 0.970 inches, regardless the front opening size. As shown in FIG. 10, the diameter DS of the domed surface 42 is equal to or smaller than the diameter DB of the sprue bushing seat 110.

Over time, sprue bushing seat 110 may become worn or damaged, causing molders to “re-face” the sprue bushing by increasing the depth of the spherical seat 110, shown in FIG. 10, beyond the original dimension, which may be, for example, 0.187 inches. This results in an increase in the diameter DB of the sprue bushing seat 110, which in turn increases the amount of contact area and thus heat conduction between the sprue bushing seat 110 and domed surface 42 of an exemplary nozzle tip. The domed surface 42 of the present invention, having a diameter DS less than or equal to that of the sprue bushing seat 110 at the face of the sprue bushing 100, for example between 0.500 inches and 0.750 inches, results in the amount of contact area and in turn heat conductivity remaining constant, regardless of any re-facing of the sprue bushing seat 110.

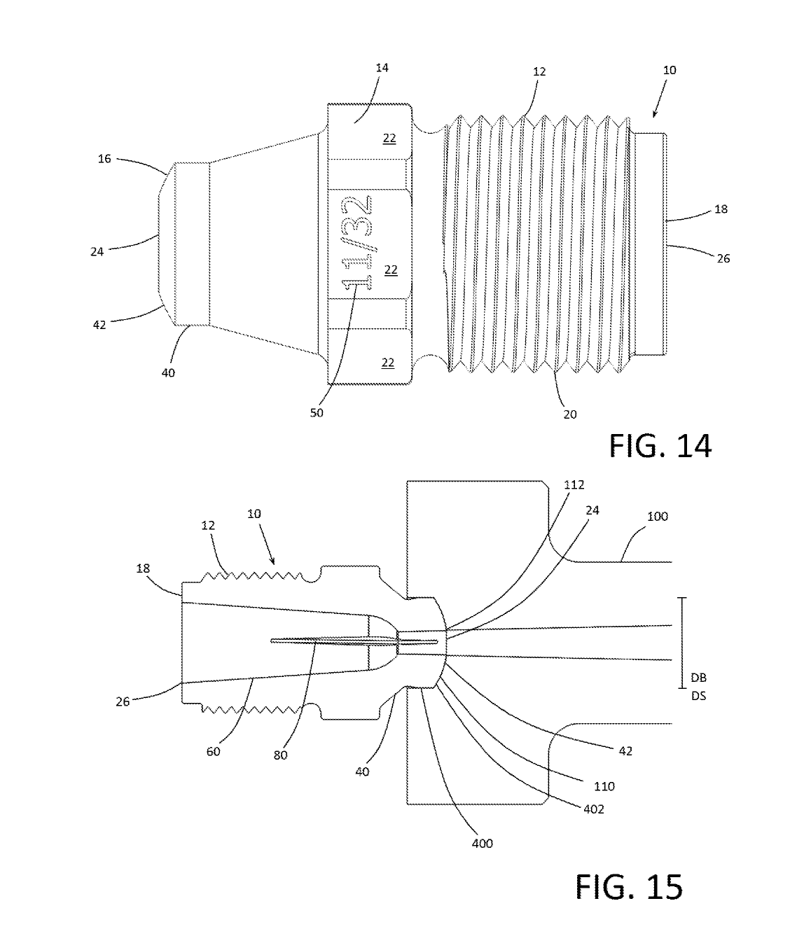

In some embodiments, the domed surface 42 may have a diameter DS equal to that DB of the sprue bushing 110. In other embodiments, the domed surface 42 may have a diameter DS less than that of diameter DB the sprue bushing 100. FIG. 14 shows another example of a nozzle tip 10 having a domed surface 42 with a smaller diameter DS than that of FIG. 10.

Since the diameter DS of the convex domed surface 42 is less than the diameter DB of the sprue bushing seat 110, the sprue bushing seat 110 can be machined deeper into the sprue bushing 100, but without increasing the diameter DB, by forming a cylindrical cavity 400, with concave surface 402 of the sprue bushing seat 110 being formed at an end of the cavity 400, thereby shifting the sprue bushing seat 110 axially further into the sprue bushing 100. As seen in FIG. 15, this cylindrical inner surface thereby creates a means of precisely aligning the nozzle tip 10 of the present invention to the sprue bushing 100, which is not possible with prior art nozzle tips.

As shown in FIG. 10 the concave surface 402 of sprue bushing seat 110 has an inner spherical radius R1, and the domed surface 42 has an outer spherical radius R2. The outer spherical radius R2 of domed surface 42 may be less than the inner spherical radius R1 of the sprue bushing seat 110, so as to eliminate gaps formed between the opening 112 in the sprue bushing 100 and the opening in the domed surface 24, which could lead to molding material leakages into such gaps. The outer spherical radius R2 is smaller than the inner spherical radius R1 of the sprue bushing. In one embodiment, the domed surface 42 outer spherical radius R2 is between 0.494 inches and 0.498 inches, for example, the domed surface 42 may have a desired outer spherical radius R2 of 0.496 inches, with a tolerance of 0.002 inches. The sprue bushing seat 110 may have an industry standard inner spherical R1 radius of 0.500 inches, which is greater than the outer spherical radius R2 of the domed surface of the present invention, allowing for greater force concentration at the front end 16 of the nozzle tip 10 and avoiding gaps that could result in leaks and the potential for “blow-back” of the machine barrel assembly.

The nozzle tip front opening 24 may be selected to maximize the flow area between the nozzle tip front opening 24 and the sprue bushing inlet opening 112. In some embodiments, this may be achieved by providing a nozzle tip front opening 24 having a front opening diameter DSO, which is smaller than the sprue bushing inlet opening 112 diameter DBO, as shown in FIG. 10. The front opening diameter DSO may be, for example, between 0.005 inches and 0.030 inches smaller than the sprue bushing inlet opening diameter DBO. For example, the nozzle tip front opening diameter DSO may be larger than 1/32 inch and smaller than the diameter of the sprue bushing opening diameter DBO. In some embodiments, the sprue bushing inlet opening 112 may be of a standard size, and the nozzle tip front opening 24 of a non-standard size, which is smaller than the sprue bushing inlet opening 112. In some embodiments, the nozzle tip front opening 24 is only slightly smaller than the sprue inlet opening 112. For example, in some embodiments, a sprue bushing 110 having an opening 112 of 0.156 inches in diameter may be used in conjunction with a nozzle tip 10 having a front opening 16 of 0.148 inches in diameter. In other embodiments, a sprue bushing 110 having an inlet opening 112 of 0.344 inches in diameter may be used in conjunction with a nozzle tip having a front opening 16 of 0.324 in diameter. The size of the nozzle tip front opening 24 in the present invention is designed to have a flow area no less than 12% of the flow area of the larger sprue bushing inlet opening 112 to which it was designed to be used in conjunction with.

The nozzle tip 10 further includes a reduced mass area 114 at a selected location along the axial length thereof. The reduced mass area helps to account for the rate of change in tip temperature during the molding cycle in front segment 64. The reduced mass area 114, extends between the hexagonal section 14 and front end 16, and as such is located between the transition plane 44 and the front end 16, as shown in FIG. 7. In one embodiment, the reduced mass area 114 has an axial extension ranging between 0.500 inches and 0.750 inches. In one embodiment, the reduced mass area 114 is located between 0.030 and 0.100 inches forward of the transition plane 44 and between 0 and 0.150 inches forward of the hexagonal section 14. The reduced mass area may be formed as a reduced diameter area of the nozzle tip 10. In the embodiment shown, the reduced mass area 114 has the smallest outer diameter of any area along the axial length of the nozzle tip 10.

As can be seen in FIGS. 1 and 2, the hexagonal section 14 has a large outer width in comparison with the remaining areas of the tip 10, and an axial length of approximately 0.360 inches, as a result forming an area of large mass. The hexagonal section 14 may be positioned at a selected axial distance from the transition plane 44, so as to avoid it transferring excess heat due to its mass to the transition plane 44. In the embodiment shown, a proximal face of the hexagonal section 14 is located at least 0.100 inches rearward of the transition plane 44, for example between 0.100 and 0.200 inches rearward of the transition plane 44. In some embodiments, the length of the nozzle tip 10 could be increased over that of standard nozzle tips if needed to accommodate for these dimensions. In some embodiments, the axial length of the hexagonal section could be reduced, for example by between 0.050 inches and 0.100 inches, to accommodate for these dimensions or to position the hexagonal section 14 even further from the transition plane 44, such as in the embodiment shown in FIG. 14. Such a nozzle tip may be employed, for example, in use with an injection mold having a very short cycle time, where fractions of a second are critical and solidification of the molding material at a faster rate is desirable.

The nozzle tip 10 further includes a land length LL, which is the axial distance between the front end 16 and the transition plane 44, as shown in FIG. 6. The land length of the nozzle tip 10 is sufficient to avoid overly rapid solidification of molding material due to conductive heat loss from the sprue bushing spherical seat. The land length LL may be between 0.200 and 0.600 inches. In one embodiment, the land length is approximately 0.300 inches.

The nozzle tip 10 may be formed of any suitable material known in the art of sufficient strength to withstand extreme injection pressures and having the appropriate thermal conductivity properties. In one embodiment, the nozzle tip 10 is formed of ANSI H-13 steel, heat treated to 48 to 52 Rockwell C. Other heat treated tool steels, such as 440 stainless, S-7, D-2 and CPM-9V could be used as well.

In some embodiments, the nozzle includes special surface coatings, such as diamond chromium or titanium nitride.

The nozzle tip 10 may further include an identifier 50 that identifies a dimension associated with the nozzle tip 10, such as the fractional size sprue bushing with which the nozzle tip 10 is designed to mate. The identifier 50 may be located on one of the wrench flats 22, as shown in FIG. 9, and may be formed, for example, by engraving.

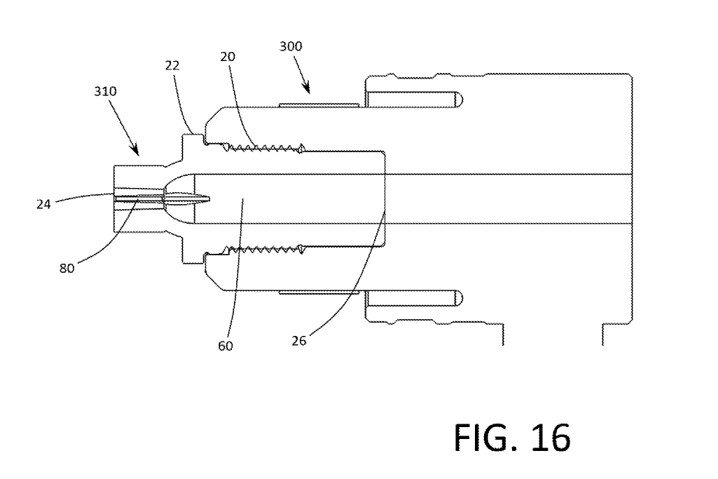

While the nozzle tip 10 illustrated and described is of the type that would typically be used at the end of a heated injection molding machine barrel assembly, which typically consists of a heated barrel, an end cap, a nozzle body and then the removable nozzle tip, the features described herein could be incorporated into nozzle tips for use with other types of assemblies as well. For example as shown in FIG. 16, fins 80 as described herein could be incorporated into nozzle tips for use with molds having an electrically heated sprue bushing or hot runner systems with hot probes 300 having removable nozzle tips 310 axially attached to the end of a nozzle body and extending to the parting line of the injection mold, or directly to the molded part. The addition of fins 80 to hot bushing or hot runner probe nozzle tips offers many of the same benefits afforded to molding machine nozzle tips, such as the accelerated solidification of molding material and a reduction in the formation of strings.

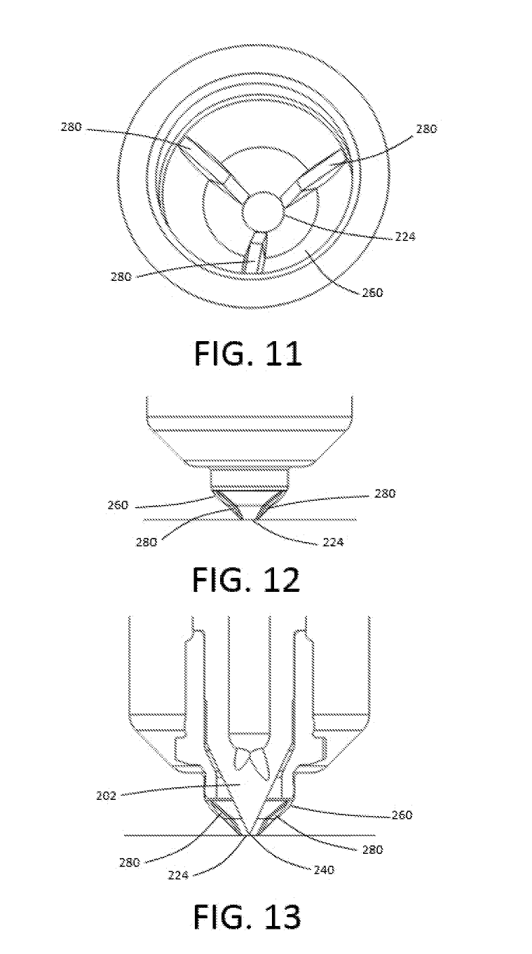

FIGS. 11-13 show an example of a hot bushing or hot runner nozzle 202 typically referred to in the art as “tip-less” or “body-less” style. As shown, the nozzle 202 has a generally conical front portion 240. The “tip-less” design could be provided with many of the nozzle tip features shown and described herein, and a person of ordinary skill in the art would be capable of adapting such features for incorporation into a tip-less nozzle. For example, the nozzle counter-bore 260 is provided with fins 280 configured similarly to the fins 80 described above. The inclusion of fins 280 would allow such a nozzle 202 to be provided with a larger front opening 224 than is typical, while avoiding the formation of strings or a tall gate vestige.

While the preferred embodiments of the invention have been described in detail above, the invention is not limited to the specific embodiments described, which should be considered as merely exemplary.

What is claimed is:

1. An injection molding nozzle tip, comprising:
a body extending along a central axis and having a front end and a rear end;
a passage extending along the axis, through the body and forming a front opening at the front end, and a rear opening at the rear end; and
at least one fin extending radially inwardly from an inner surface of the passage.

2. The nozzle tip in claim 1, further comprising a transition plane located along the axis and intersecting the passage.

3. The nozzle tip of claim 2, wherein the transition plane is located between 0.200 and 0.600 inches from the front end.

4. The nozzle tip of claim 1, wherein each of the fins comprises a substantially planar radial inner surface.

5. The nozzle tip of claim 2, wherein the passage comprises a front segment located between the transition plane and the front end, and a rear segment located between the transition plane and the rear end, and wherein the fins are located within the front segment.

6. The nozzle tip of claim 2, wherein the passage comprises a front segment located between the transition plane and the front end, and a rear segment located between the transition plane and the rear end, and wherein the fins are located within the front segment and the rear segment.

7. The nozzle tip of claim 6, wherein:
each of the fins comprises a rear portion located within the rear segment, the rear portion having a first radial inner surface;
the first radial inner surface is disposed at a first angle with respect to the axis, such that the rear portion increases in radial height in a direction moving from the rear end to the transition plane; and
each of the fins has a maximum radial height at the transition plane.

8. The nozzle tip of claim 6, wherein:
each of the fins comprises a front portion located with the front segment, the front portion having a second radial inner surface;
the second radial inner surface is disposed at a second angle with respect to the axis, such that the front portion increases in radial height in a direction moving from the front end to the transition plane; and
each of the fins has a maximum radial height at the transition plane.

9. The nozzle tip of claim 6, wherein:
each of the fins comprises a front portion located with the front segment and a rear portion located within the rear segment, the rear portion having a first radial inner surface and the front portion having a second radial inner surface;
the first radial inner surface is disposed at a first angle with respect to the axis, such that the rear portion increases in radial height in a direction moving from the rear end to the transition plane;
the second radial inner surface is disposed at a second angle with respect to the axis, such that the front portion increases in radial height in a direction moving from the front end to the transition plane; and
each of the fins has a maximum radial height at the transition plane.

10. The nozzle tip of claim 1, wherein the at least one fin comprises a plurality of fins that do not contact each other.

11. The nozzle tip of claim 1, further comprising an identifier indicating a dimension associated with the nozzle tip on an exterior surface thereof.

12. An injection molding nozzle tip, comprising:
a body extending along a central axis and having a front end and a rear end;
a passage extending along the axis, through the body and forming a front opening at the front end, and a rear opening at the rear end; and
a transition plane located along the axis and intersecting the passage;
wherein the passage comprises a front segment located between the transition plane and the front end, and a rear segment located between the transition plane and the rear end;
the rear segment comprises a first section located adjacent to the rear end and a second section located between the first section and the transition plane;
the first section comprises a conical inner surface that narrows from the rear end to the second section;
the second section comprises a curved inner surface that narrows from the first section to the transition plane; and
the curved inner surface has a radial center point offset from the central axis.

13. The nozzle tip of claim 12, wherein the curved inner surface has a radius with an extension between ½ inch to 1½ inches that narrows in a direction extending from the rear end to the transition plane.

14. An injection molding assembly, comprising:
an injection mold having an inlet opening in communication with a molding cavity;
an injection molding nozzle tip configured for engagement with the mold and having a body extending along a central axis, a front end in contact with the inlet opening and defining a front end opening, a rear end defining a rear end opening, and a passage for transmission of molding material from the rear end opening to the front end opening;
wherein the inlet opening has an inlet opening diameter and the front end opening has a front end opening diameter; and the front end opening diameter is smaller than the inlet opening diameter.

15. The assembly of claim 14, wherein the front end opening diameter is between 0.005 and 0.030 inches smaller than the inlet opening diameter.

16. An injection molding assembly, comprising:
an injection mold having an inlet having a concave surface and defining an inlet opening in communication with a molding cavity;
an injection molding nozzle tip configured for engagement with the mold and having a body extending along a central axis, a front end including a nodule having a forward extending domed convex surface in contact with the inlet opening and complimentary to the concave surface, and a front end opening defined in the domed convex surface, a rear end defining a rear end opening and a passage for transmission of molding material from the rear end opening to the front end opening;
wherein the concave surface has a standard concave surface radius, and the convex surface has a non-standard convex surface radius; and
the convex surface radius is smaller than the concave surface radius.

17. The assembly of claim 16, wherein the convex surface radius is between 0.002 inches and 0.006 inches smaller than the concave surface radius.

18. An injection molding nozzle tip, comprising:
a body extending along a central axis and having a front end and a rear end;
a passage for transmission of molding material extending along the axis, through the body and forming a front opening at the front end, and a rear opening at the rear end; and
a hexagonal section forming a plurality of wrench flats on an exterior surface of the body, wherein the hexagonal section is axially located between the front end and the rear end;
wherein the body has a reduced mass area, formed as an area of minimum diameter and extending from the hexagonal section and the front end.
